(19) United States
(12) Patent Application Publication
(10) Pub. No.: US 2018/0236633 A1
(43) Pub. Date: Aug. 23, 2018

(54) Slurry and Slurry Delivery Technique for Chemical Mechanical Polishing of Copper

(71) Applicant: Applied Materials, Inc., Santa Clara, CA (US)

(72) Inventors: Ranga Rao Arnepalli, Veeravalli post (IN); Sudhanshu Singh, Bhandara (IN); Darshan Thakare, Thane (IN); Prerna Goradia, Mumbai (IN); Robert Jan Visser, Menlo Park, CA (US)

(21) Appl. No.: 15/477,943

(22) Filed: Apr. 3, 2017

(30) Foreign Application Priority Data
Feb. 17, 2017 (IN) 201741005665

(51) Int. Cl. B24B 37/22; B24B 57/02; C09G 1/02; C09K 3/14

(52) U.S. Cl. CPC B24B 37/22; C09K 3/1409; C09G 1/02; B24B 57/02

(57) ABSTRACT

A method of polishing includes bringing a metal layer of a substrate into contact with a polishing pad, generating relative motion between the substrate and the polishing pad, and while the metal layer is in contact with the polishing pad and the substrate is moving relative to the polishing pad, alternating between supplying a first polishing liquid and a second polishing liquid to an interface between the metal layer. The first polishing liquid is abrasive-free and includes an oxidizer, and the second polishing liquid includes abrasive particles and a complexing compound to complex with ions of the metal of the metal layer.

### TECHNICAL FIELD

The present invention relates generally to chemical mechanical polishing, e.g., of copper, using one or more polishing liquids.

### BACKGROUND

In the process of fabricating modern semiconductor integrated circuits (IC), it is often necessary to planarize the outer surface of the substrate. For example, planarization may be needed to polish away a conductive filler layer until the top surface of an underlying dielectric layer is exposed, leaving the conductive material between the raised pattern of the dielectric layer to form vias, plugs and lines that provide conductive paths between thin film circuits on the substrate. A barrier layer can be disposed between the dielectric layer and the conductive layer.

Chemical mechanical polishing (CMP) is one accepted method of planarization. This planarization method typically requires that a substrate be mounted on a carrier head. The exposed surface of the substrate is typically placed against a rotating polishing pad. The polishing pad can have a durable roughened surface. The carrier head provides a controllable load on the substrate to push it against the polishing pad while the substrate and polishing pad undergo relative motion.

An abrasive polishing slurry is typically supplied to the surface of the polishing pad. Commonly used slurries include silica or alumina particles.

### SUMMARY

In one aspect, a slurry for chemical mechanical polishing of a copper layer includes water, 1-4 wt. % of porous abrasive particles of substantially homogenous composition that consist of alumina and/or silica, 0.1-4 wt. % of an oxidizer, 0.25-5 wt. % of a first organic complexing compound for copper ion complexion, and 0.25-5 wt. % of a second organic complexing compound for copper ion complexion. The first organic complexing compound is a carboxylic acid. The second organic is an imidazole.

Implementations may include one or more of the following.

The porous zeolite abrasive particles may have pores with an average pore diameter of approximately 2-8 nanometers. The abrasive particles may have a particle size of 300 to 350 nanometers.

The oxidizer may include hydrogen peroxide, ammondium peroxide, monopersulfate, potassium permanganate, iodate, or dipersulfate. The first organic complexing compound may include lactic acid, tartaric acid, citric acid or oxalic acid.

In another aspect, a method of polishing includes bringing a metal layer of a substrate into contact with a polishing pad, generating relative motion between the substrate and the polishing pad, supplying an abrasive-free first polishing liquid to an interface between the metal layer and the polishing pad while the metal layer is in contact with the polishing pad and the substrate is moving relative to the polishing pad, and supplying a second polishing liquid to the interface between the metal layer and the polishing pad after supplying the first polishing liquid for a first period time and while the metal layer is in contact with the polishing pad and the substrate is moving relative to the polishing pad. The first polishing liquid includes an oxidizer. The second polishing liquid includes abrasive particles and a complexing compound to complex with ions of the metal of the metal layer.

Implementations may include one or more of the following.

The metal layer may be a copper layer. The second polishing liquid may include the oxidizer or a second oxidizer. The second polishing liquid may be a slurry including 1-4 wt. % of porous zeolite abrasive particles of substantially homogenous composition, 0.1-4 wt. % of oxidizer, 0.25-5 wt. % of a first organic complexing compound for copper ion complexion, and 0.25-5 wt. % of a second organic complexing compound for copper ion complexion. The first organic complexing compound may be a carboxylic acid. The second organic may be an imidazole.

The first time period may be 5 to 15 seconds. Polishing with the second polishing liquid may be performed until a top surface of a patterned layer underlying the metal layer is exposed.

In another aspect, a method of polishing includes bringing a metal layer of a substrate into contact with a polishing pad, generating relative motion between the substrate and the polishing pad, and while the metal layer is in contact with the polishing pad and the substrate is moving relative to the polishing pad, alternating between supplying a first polishing liquid and a second polishing liquid to an interface between the metal layer. The first polishing liquid is abrasive-free and includes an oxidizer, and the second polishing liquid includes abrasive particles and a complexing compound to complex with ions of the metal of the metal layer.

Implementations may include one or more of the following.

Alternating between supplying the first polishing liquid and the second polishing liquid may include alternating between supplying the first polishing liquid for a first time period and supplying the second polishing liquid for a second time period. A duration of the first time period may equal a duration of the second time period. A duration of the first time period may be less than a duration of the second time period. A duration of the first period may be 5 seconds to 1 minute, and a duration of the second period may be 5 seconds to 1 minute. The duration of the first period may be 5 to 15 seconds. The duration of the second period may be 15 to 45 seconds. The metal layer may be a copper layer. The second polishing liquid may include the oxidizer or a second oxidizer.

Advantages may optionally include one or more of the following.

The polishing rate of a metal layer and/or the metal to barrier layer selectivity of the polishing process can be improved, and/or the cost of the slurry can be decreased. Other polishing criteria, such as planarization and defect rate, can be maintained. A copper conductive layer can be polished until an underlying barrier layer or dielectric layer is exposed with a commercially viable polishing rate and selectivity.

### BRIEF DESCRIPTION OF DRAWINGS

FIGS. 1A and 1B illustrate polishing of a substrate having a conductive layer over a patterned dielectric layer.

FIG. 2 is a graph illustrating polishing rate of cupper as a function of time using an “incubation” technique.

FIG. 3 is a schematic cross-sectional view of a polishing system.

### DETAILED DESCRIPTION

One step in semiconductor IC device fabrication is polishing of the conductive layer until the underlying barrier layer or dielectric layer is exposed. One possible conductive layer is copper. There is significant room for improvement in slurries used in CMP of copper. For example, existing slurries may 1) have poor copper removal rates, 2) have poor selectivity in that they remove not only the copper layer, but also the underlying barrier or dielectric layer, 3) cause surface defects, such as excessive pitting, corrosion or roughness of the copper material, resulting in reduced device performance and device yield, 4) have difficulty achieving planarity, and 5) result in poor IC electrical performance.

A slurry composition that can provide superior copper removal rates and high selectivity of copper relative to tantalum can include abrasive particles of alumina, silica, or combinations such as aluminum silicate or aluminosilicate, e.g., porous zeolite.

In addition, performing an “incubation” with a first polishing liquid that includes an oxidizer but no abrasive particles, and then conducting polishing with a second polishing liquid that includes abrasive particles, can improve the overall polishing rate of a metal layer. Moreover, alternating between the first polishing liquid and the second polishing liquid may improve the polishing rate even further.

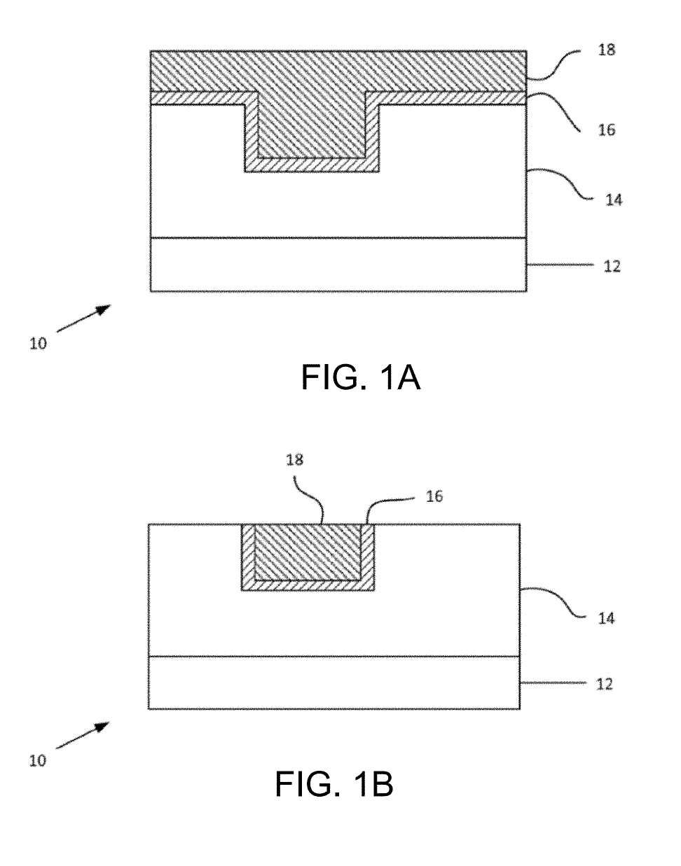

Referring to FIG. 1A, during an integrated circuit fabrication process, a substrate 10 can include a glass or semiconductor substrate 12, a patterned dielectric layer 14, and a conductive layer 18 disposed over the dielectric layer 14. A barrier layer 16 can be disposed between the dielectric layer 14 and the conductive layer 18. Additional unillustrated conductive and/or dielectric layers can be formed between the substrate 12 and the dielectric layer 14.

The dielectric layer 14 can be an oxide, e.g., silicon oxide, or a low-k dielectric, e.g., a porous carbon-doped oxide. The conductive layer 18 can be a metal, e.g., copper. In some implementations, the conductive layer consists of copper. The barrier layer 16 can be tantalum or tantalum nitride.

As noted above, current commercially available slurries for the polishing of copper do not give satisfactory CMP performance because they have low copper removal rates and/or they have low copper to barrier layer selectivity.

Polishing Liquid

A proposed slurry chemistry that might address these problems can include abrasive particles that contain alumina and/or silica, an oxidizer, a complexing agent for copper ion complexion, an inhibitor, and a solvent such as water.

The oxidizer oxidizes the copper to provide easy abrasion of the top surface of the copper layer, and the abrasive particles provide abrasion of the oxidized surface of the copper layer. The complexing agent provides complexion for copper ions, which prevents settling of the metal from the slurry. The inhibitor assists in anisotropic etching or passivating the recessing areas of the top surface of the copper layer.

Table 1 summarizes the composition of the slurry:

| SLURRY COMPONENT | WT % OF THE SLURRY |
|---|---|
| Alumina and/or silica containing | 1-3½ |
| abrasive particles | |
| Oxidizer | 0.1-10 |
| Complexing Compound | 0.1-10 |
| Inhibitor | 0.1-5 |

The abrasive particles can have an outer surface that consists of alumina and/or silica. For example, the abrasive particles can be substantially pure alumina, or be substantially pure silica, or be a combination of alumina and silica, such as aluminum silicate or aluminosilicate. In some implementations, the abrasive particles are porous zeolite particles.

The abrasive particles can be of substantially homogenous composition, e.g., consists of alumina and/or silica, rather than being coated on a core of different composition. In some implementations, the abrasive particles consist of an aluminum silicate or aluminosilicate.

The abrasive particle can be nanoparticles, i.e., average particle diameter less than 100 nm. For example, the particles can be alumina particles having an average particle diameter less than 50 nm, e.g., less than 40 nm. As another example, the particles can be silica particles having an average particle diameter less than 75 nm, e.g., less than 50 nm. The particles can have an average particle diameter greater than 5 nm, e.g., greater than 10 nm.

The surfaces of the particles, e.g., zeolite particles, can have pores. The pores in the surfaces of the zeolite particles can have an average pore diameter of about 0.1-8 nm, e.g., 0.1-2 nm, 2-8 nm, or 3-6 nm (synthetic aluminum silicate has an average pore diameter of 0.1-2 nanometers, while natural mesoporous aluminum silicate has an average pore diameter of about 4 nanometers).

The porous zeolite particles can have a particle size of 300-350 nanometers, e.g., 310-340 nanometers.

The zeolite particles can have a hardness of about 6 on the Mohs hardness scale and can have a density of about 2.8 g/cm³. A solid component of the porous zeolite particles can be about 9.5 wt. % Al₂O₃, 82.5 wt. % SiO₂, and 8 wt. % Na₂O and can have an inorganic chain structure. In some cases, water molecules are embedded in the particles. In such cases, the zeolite particles can be about 0.5 wt. % H₂O; the remainder is the solid component.

In some implementations, all the particles have substantially the same composition, e.g., all the particles are alumina, silica, alumina silicate or aluminosilicate. In some implementations, two or more different kinds of abrasive particles can be present in the slurry. For example, the slurry can include first abrasive particles of a first composition, e.g., alumina silicate or aluminosilicate, and second abrasive particles of a different, second composition, e.g., alumina or silica. In this case the total content of the abrasive particles can be 1-3½ wt. %. Half or more of the abrasive particles can be the alumina silicate particles.

The oxidizer can include one or more of hydrogen peroxide, ammonium hydroxide, monopersulfate, potassium permanganate, iodate, or dipersulfate. In some implementations, the oxidizer is provided by hydrogen peroxide.

The oxidizer can be at least 0.1 wt. %, 0.25 wt. %, 0.5 wt. %, 0.75 wt. %, or 1 wt. %, of the slurry. The oxidizer can be at most 10 wt. %, 5 wt. %, 3 wt. %, or 2 wt. %, of the slurry. In some implementations, the oxidizer is about 1%, of the slurry.

In some implementations, the slurry does not include an oxidizer. So other slurry components provide only trivial oxidation as compared to a dedicated oxidizer such as hydrogen peroxide.

The organic complexing compound is a substance capable of forming a complex compound with ions of the metal being polished, copper metal ions. Thus, the complexing compound forms coordinate bonds with the metal ions. The organic complexing compound can include one or more organic acids, e,g., a carboxylic acid, such as tartaric acid, citric acid, oxalic acid, lactic acid, or glyceric acid. The organic complexing compound can also include imidazole and/or polyethyleneimine. Other complexing compounds include glycine, acetic acid, ethylenediamine, glycolic acid, phthalic acid salt, and arginine. Arginine is an amino acid, but arginine based slurries are inherently alkaline, whereas the other combinations listed above with peroxide are inherently acidic. Arginine can also inhibit silicon dioxide polishing, even in highly alkaline slurries.

The organic complexing compound can be can be at least 0.1 wt. %, 0.25 wt. %, 0.5 wt. %, 0.75 wt. %, or 1 wt. %, of the slurry. The organic complexing compound can be at most 10 wt. %, 5 wt. %, 3 wt. %, or 2 wt. %, of the slurry.

In some implementations, the complexing compound includes multiple components. For example, the organic complexing compound can include both imidazole and a carboxylic acid, e.g., tartaric acid or citric acid. For example, the organic complexing compound can include citric acid at about 1 wt. % of the slurry and imidazole at about 1 wt. % of the slurry. The imidazole can act as both a complexing agent to dissolve the abraded species and a corrosion inhibitor.

The slurry can also include a metal corrosion inhibitor, e.g., a copper corrosion inhibitor. The corrosion inhibitor can include one or more of a pyrimidine, e.g., 2-aminopyrimidine, a benzothiazole, e.g., 2-mercaptobenzothiazole, or an imidazole derivative, e.g., a benzimidazole, e.g., 2-mercaptobenzimidizole.

The corrosion inhibitor can be can be at least 0.01 wt. %, 0.05 wt. %, 0.1 wt %, or 0.2 wt % of the slurry. The corrosion inhibitor can be at most 5 wt. %, 2.5 wt. %, 1 wt. %, or 0.5 wt. %, of the slurry. In some implementations, the corrosion inhibitor is about 0.25 wt. %, of the slurry.

In some implementations, the slurry does not include a corrosion inhibitor. So other slurry components provide only trivial corrosion inhibition as compared to a dedicated corrosion inhibitor such as benzimidazole.

In some implementations, one slurry component can provide the functionality of both a corrosion inhibitor and an organic complexing compound. For example, polyethyleneimine may act as both a copper corrosion inhibitor and an organic complexing compound.

The pH of the slurry may be in the range of 8-13, e.g., 10-11. If necessary, the slurry can also include a pH adjustor to set the pH of the slurry. The pH adjustor can be KOH.

Polishing Methods

The slurry described above can be used to polish a copper conductive layer until an underlying barrier layer or dielectric layer is exposed.

However, by performing an “incubation” with a first polishing liquid that includes an oxidizer but no abrasive particles, and then conducting polishing with a second polishing liquid that includes abrasive particles, the effective polishing rate can be even further improved.

The first polishing liquid can include water and oxidizer, but does not include abrasive particles. The oxidizer can be the material and have the concentration noted above for the example slurry, e.g., 0.1-10 wt. %. The first polishing liquid need not include the corrosion inhibitor or the organic complexing compound. In some implementations, the first polishing liquid consists of water and the oxidizer, e.g., hydrogen peroxide. In some implementations, the first polishing liquid consists of water and the oxidizer, e.g., hydrogen peroxide, and the inhibitor, e.g., a pyrimidine, a benzothiazole, or a benzimidazole.

The second polishing liquid can be a slurry that includes abrasive particles, e.g., aluminum silicate particles, e.g., as described above. In particular, the second polishing liquid can include abrasive particles and a complexing compound, e.g., each as described above. In some implementations, the second polishing liquid includes multiple complexing compounds, e.g., both citric acid and imidazle. The second polishing liquid can optionally include an oxidizer, e.g., as described above. The oxidizer of the second polishing liquid can be the same composition or a different composition than the first oxidizer. For example, both the first and second polishing liquid can use hydrogen peroxide. Thus, the second polishing slurry can be a slurry as described in the polishing liquid section above.

### Example 1

Bulk polishing of a substrate having a copper conductive layer was conducted using a microporous polyurethane pad with a platen rotation rate of 90-110 rpm and a down force on the substrate of 2 psi. A first polishing liquid was supplied to the polishing pad for 15 seconds. Then a second polishing liquid was supplied for 15-60 seconds, and thereafter the substrate was removed from the polisher. The total material removed was measured, and the polishing rate over the time that the second polishing liquid supplied was calculated (from prior experimentation, the first polishing liquid results in negligible material removal).

The first polishing liquid had water and 1 wt. % hydrogen peroxide.

The second polishing liquid had water, 1 wt. % aluminum silicate particles, 1 wt. % hydrogen peroxide, 1 wt. % citric acid, and 1 wt. % imidazole.

The polishing technique achieved a maximum polishing rate of about 900 nm/min after about 30 seconds of polishing.

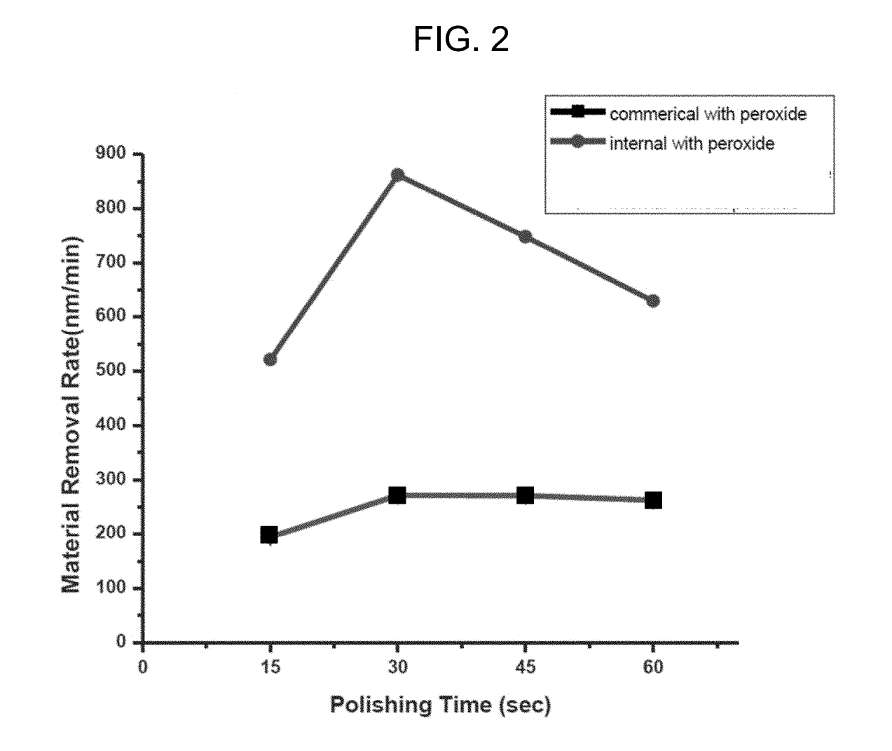

FIG. 2 is a graph comparing the performance of two slurries under this incubation polishing technique. Bulk polishing of a copper conductive layer was conducted using a microporous polyurethane pad with a platen rotation rate of 90 rpm and a down force on the wafer of 2 psi.

In both tests, a first polishing liquid of water and 1 wt. % hydrogen peroxide was supplied to the polishing pad for 15 seconds.

For the first test, a commercially available slurry which was diluted to 1% silica particle and to which 1 wt. % hydrogen peroxide had been added was then supplied to the polishing pad.

For the second test, the slurry described above (in Example 1) was used, i.e., water, 1 wt. % aluminum silicate particles, 1 wt. % hydrogen peroxide, 1 wt. % citric acid, and 1 wt. % imidazole.

As illustrated, the commercial slurry achieved a maximum polishing rate of about 350 nm/min at about 30 seconds, whereas the slurry with aluminum silicate abrasive particles achieved a maximum polishing rate of about 900 nm/min at about 30 seconds but then fell off.

By alternating polishing liquids, with the first polishing liquid having the oxidizer supplied for a first time period, and the second polishing liquid having the abrasive particles supplied for a second time period, it may be able to achieve a consistently high polishing rate. In this alternating technique the first polishing liquid is supplied, then the second polishing liquid, then the first polishing liquid, then the second polishing liquid, etc. In some implementations, the system cycles between three polishing liquids.

To perform this alternating technique, in operation, during polishing of a particular metal layer, e.g., copper layer, on a substrate, the two (or more) polishing liquids are supplied in an alternating manner until the polishing endpoint. Each polishing liquid can be supplied for at least 5 seconds, e.g., 5 seconds to 1 minute, e.g., 15-30 seconds, e.g., 15 or 30 seconds (in comparison, a typical total polishing time to remove a metal layer is about 2-3 minutes). The duration of the “pulses” for each polishing liquid is a non-trivial portion of the expected total polishing time. For example, each pulse can be at least 5%, e.g., at least 7.5%, e.g., at least 10% of the total polishing time.

The duration of each period in which the first polishing liquid having the oxidizer is supplied can be up to 30 seconds, e.g., up to 15 seconds, e.g., up to 10 seconds. The duration of each period in which the second polishing liquid having the abrasive is supplied can be at least 15 seconds, e.g., at least 30 seconds, e.g., at least 45 seconds.

In some implementations, the durations of the “pulses” for the two polishing liquids are the same, e.g., 15 seconds of the first polishing liquid, followed by 15 seconds of the second polishing liquid, followed by 15 seconds of the first polishing liquid, etc. However, the duration of the “pulses” need not be the same for each polishing liquid. For example, polishing could be performed using 10 seconds of the first polishing liquid, followed by 30 seconds of the second polishing liquid, followed by 10 seconds of the first polishing liquid, etc.

Polishing System

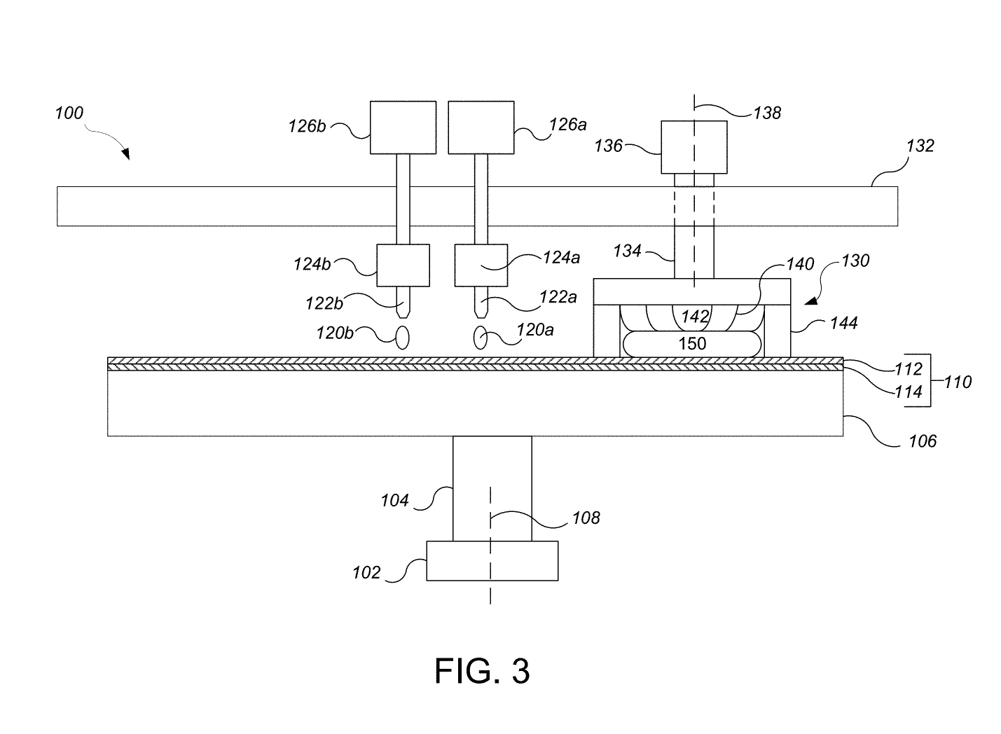

FIG. 3 illustrates an example of a chemical mechanical polishing system 100 that can be used for polishing of packaging material. The polishing system 100 includes a rotatable disk-shaped platen 106 on which a polishing pad 110 is situated. The platen 106 is operable to rotate about an axis 108. For example, a motor 102 can turn a drive shaft 104 to rotate the platen 24. The polishing pad 110 can be a two-layer polishing pad with an outer layer 112 and a softer backing layer 114.

The polishing system 100 can include a supply port or a combined supply-rinse arm 122 to dispense a slurry 120 as described above, i.e., including abrasive nanoparticles with a cerium oxide (ceria) surface, an amine, water, and optionally TMAH, onto the polishing pad 110. In some implementations, a pump 124 is used to direct the slurry from a reservoir 126 to the supply port.

The polishing system 100 can include a pad conditioner apparatus with a conditioning disk to maintain the condition of the polishing pad.

A carrier head 130 is operable to hold a workpiece 150 of the packaging against the polishing pad 110. The carrier head 130 is suspended from a support structure 132, e.g., a carousel or a track, and is connected by a drive shaft 134 to a carrier head rotation motor 136 so that the carrier head can rotate about an axis 138. Optionally, the carrier head 130 can oscillate laterally, e.g., on sliders on the carousel or track 132; or by rotational oscillation of the carousel itself. The carrier head can apply a pressure of 1-6 psi on the substrate.

The carrier head 130 can include a flexible membrane 140 having a substrate mounting surface to contact the back side of the workpiece 150, and a plurality of pressurizable chambers 152 to apply different pressures to different zones, e.g., different radial zones, on the workpiece 150. The carrier head 130 can also include a retaining ring 154 to hold the workpiece below the membrane 140.

In operation, the platen 106 is rotated about its central axis 108, and the carrier head 130 is rotated about its central axis 138 and translated laterally across the top surface of the polishing pad 110.

However, the above described slurries can be used in a variety of polishing systems. Either the polishing pad, or the carrier head, or both can move to provide relative motion between the polishing surface and the substrate. The polishing pad can be a circular (or some other shape) pad secured to the platen, or a continuous or roll-to-roll belt.

In addition, in some implementations, the abrasive particles described above can be incorporated into a fixed-abrasive polishing pad rather than a slurry. Such a fixed abrasive polishing pad can include the nanoparticles embedded in a binder material. The binder material can be derived from a precursor which includes an organic polymerizable resin which is cured to form the binder material. Examples of such resins include phenolic resins, urea-formaldehyde resins, melamine formaldehyde resins, acrylated urethanes, acrylated epoxies, ethylenically unsaturated compounds, aminoplast derivatives having at least one pendant acrylate group, isocyanurate derivatives having at least one pendant acrylate group, vinyl ethers, epoxy resins, and combinations thereof. The binder material can be disposed on a backing layer. The backing layer can be a polymeric film, paper, cloth, a metallic film or the like.

In the case of the fixed-abrasive polishing pad, the workpiece can be polished in the presence of a polishing liquid that includes the remaining components of the slurry discussed above, i.e., an oxidizer, a complexing compound, and an inhibitor.

Although the polishing technique described above using alternating polishing liquids describes using aluminum silicate abrasive particles, other materials, e.g., silica, alumina or ceria, could be used for the abrasive particles in the alternating polishing liquid technique.

The above described slurry can be used in a variety of polishing systems. Either the polishing pad, or the carrier head, or both can move to provide relative motion between the polishing surface and the substrate. The polishing pad can be a circular (or some other shape) pad secured to the platen, or a continuous or roll-to-roll belt.

The substrate can be, for example, a product substrate (e.g., which includes multiple memory or processor dies), a test substrate, a bare substrate, or a gating substrate. The substrate can be at various stages of integrated circuit fabrication, e.g., it can include one or more deposited and/or patterned layers. The term substrate can include circular disks and rectangular sheets.

What is claimed is:

1. A slurry for chemical mechanical polishing of a copper layer, comprising:
water;
abrasive particles of substantially homogenous composition, the abrasive particles consisting of silica and/or alumina, the abrasive particles being 1-4 wt. % of the slurry;
an oxidizer, the oxidizer being 0.1-4 wt. % of the slurry;
a first organic complexing compound for copper ion complexion, the first organic complexing compound being a carboxylic acid and being 0.25-5 wt. % of the slurry; and
a second organic complexing compound for copper ion complexion, the second organic being imidazole and being 0.25-5 wt. % of the slurry.

2. The slurry of claim 1, wherein the abrasive particles comprise porous zeolite particles having pores with an average pore diameter of approximately 2-8 nanometers.

3. The slurry of claim 1, wherein the abrasive particles have a particle size of 300 to 350 nanometers.

4. The slurry of claim 1, wherein the oxidizer comprises hydrogen peroxide, ammondium peroxide, monopersulfate, potassium permanganate, iodate, or dipersulfate.

5. The slurry of claim 4, wherein the oxidizer comprises hydrogen peroxide.

6. The slurry of claim 1, wherein the first organic complexing compound comprises lactic acid, tartaric acid, citric acid or oxalic acid.

7. The slurry of claim 1, wherein the abrasive particles have an average particle size less than 100 nm.

8. The slurry of claim 7, wherein the abrasive particles consist of alumina.

9. The slurry of claim 1, wherein the abrasive particles are aluminum silicate or aluminosilicate.

10. The slurry of claim 9, wherein the abrasive particles are porous zeolite.

11. A method of polishing a metal layer on a substrate, comprising:
bringing the metal layer of the substrate into contact with a polishing pad;
generating relative motion between the substrate and the polishing pad;
while the metal layer is in contact with the polishing pad and the substrate is moving relative to the polishing pad, supplying an abrasive-free first polishing liquid to an interface between the metal layer and the polishing pad, the first polishing liquid comprising an oxidizer; and
after supplying the first polishing liquid for a first period time and while the metal layer is in contact with the polishing pad and the substrate is moving relative to the polishing pad, supplying a second polishing liquid to the interface between the metal layer and the polishing pad, the second polishing liquid comprising abrasive particles and a complexing compound to complex with ions of the metal of the metal layer.

12. The method of claim 11, wherein the metal layer is a copper layer.

13. The method of claim 11, wherein the second polishing liquid comprises the oxidizer or a second oxidizer.

14. The method of claim 11, wherein the second polishing liquid is a slurry comprising
water,
abrasive particles of substantially homogenous composition, the abrasive particles consisting of silica and/or alumina, the abrasive particles being 1-4 wt. % of the slurry,
an oxidizer, the oxidizer being 0.1-4 wt. % of the slurry,
a first organic complexing compound for copper ion complexion, the first organic complexing compound being a carboxylic acid and being 0.25-5 wt. % of the slurry, and
a second organic complexing compound for copper ion complexion, the second organic being imidazole and being 0.25-5 wt. % of the slurry.

15. The method of claim 11, wherein the first time period is 5 to 15 seconds.

16. The method of claim 11, comprising polishing with the second polishing liquid until a top surface of a patterned layer underlying the metal layer is exposed.

17. A method of polishing a metal layer on a substrate, comprising:
bringing the metal layer of the substrate into contact with a polishing pad;
generating relative motion between the substrate and the polishing pad; and
while the metal layer is in contact with the polishing pad and the substrate is moving relative to the polishing pad, alternating between supplying a first polishing liquid and a second polishing liquid to an interface between the metal layer, wherein the first polishing liquid is abrasive-free and comprises an oxidizer, and wherein the second polishing liquid comprises abrasive particles and a complexing compound to complex with ions of the metal of the metal layer.

18. The method of claim 17, wherein alternating between supplying the first polishing liquid and the second polishing liquid comprises alternating between supplying the first polishing liquid for a first time period and supplying the second polishing liquid for a second time period.

19. The method of claim 18, wherein a duration of the first time period equals a duration of the second time period.

20. The method of claim 18, wherein a duration of the first time period is less than a duration of the second time period.

21. The method of claim 18, wherein a duration of the first period is 5 seconds to 1 minute and a duration of the second period is 5 seconds to 1 minute.

22. The method of claim 21, wherein the duration of the first period is 5 to 15 seconds.

23. The method of claim 21, wherein the duration of the second period is 15 to 45 seconds.

24. The method of claim 21, wherein the metal layer is a copper layer.

25. The method of claim 18, wherein the second polishing liquid comprises the oxidizer or a second oxidizer.
